(19) United States
(12) Patent Application Publication
(10) Pub. No.: US 2025/0028471 A1
(43) Pub. Date: Jan. 23, 2025

(54) RESYNCHRONIZATION OF OBJECTS IN A VIRTUAL STORAGE SYSTEM

(71) Applicant: VMware, Inc., Palo Alto, CA (US)

(72) Inventors: Venkata RAMANAN, Sunnyvale, CA (US); Eric KNAUFT, San Francisco, CA (US); Pascal RENAULD, Palo Alto, CA (US); Sandeep RANGASWAMY, Mountain View, CA (US); Sudheer THOKALA, Dublin, CA (US)

(21) Appl. No.: 18/356,125

(22) Filed: Jul. 20, 2023

(51) Int. Cl. G06F 3/06

(52) U.S. Cl. CPC G06F 3/065; G06F 3/0619; G06F 3/067

(57) ABSTRACT

An example method of resynchronizing a first replica of an object and a second replica of an object in an object storage system, includes: determining, by storage software in response to the second replica transitioning from failed to available, a stale sequence number for the second replica, the storage software having associated the stale sequence number with the second replica when the second replica failed; querying, by the storage software, block-level metadata for the object using the stale sequence number, the block-level metadata relating logical blocks of the object with sequence numbers for operations on the object; determining, by the software as a result of the querying, a set of the logical blocks each related to a sequence number being the same or after the stale sequence number; and copying, by the storage software, data of the set of logical blocks from the first replica to the second replica.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by control plane software that communicates with virtualization software (e.g., hypervisor) installed in the host computers. Applications execute in virtual computing instances supported by the virtualization software, such as virtual machines (VMs) and/or containers. Host computers and virtual computing instances utilize persistent storage, such as hard disk storage, solid state storage, and the like. In some configurations, local storage devices of the hosts can be aggregated to form a virtual storage area network (SAN) and provide shared storage for the hosts. The virtual SAN can be object-based storage (also referred to as object storage). With object storage, data is managed as objects as opposed to a file hierarchy. Each object includes the data being persisted and corresponding metadata.

Objects in object storage, such as a virtual SAN, can be replicated to provide for fault tolerance. For example, an object can have multiple replicas stored in the object storage. For each write to the object, the storage software also applies the write to each replica of the object. In case of a fault or faults, an object in the object storage is still available for reading and writing if there is at least one replica unaffected by the fault. When the fault(s) are resolved, the object replicas need to be resynchronized. The object may have received writes during the time that a replica was unavailable due to the fault(s). The software resynchronizes the replicas that have become out-of-date.

To avoid performing a complete copy-over, one technique is to track the delta of operations that need to be copied over to a faulty replica in the resynchronization process. For example, when a fault occurs and a replica is unavailable, the storage software can create a bitmap data structure. Each bit represents a portion of the object. When a portion of an object is modified, a corresponding bit in the bitmap is set. After the fault is resolved, the software resynchronizes only those portions of the object identified by the set bits in the bitmap.

There are several inefficiencies with the bitmap approach to resynchronization of object replicas in object storage. The granularity of the bitmap can lead to more resynchronization than required. Increasing the granularity of the bitmap increases cost. For example, with a bitmap of size 128 kilobytes (KB) and an object size of 256 gigabytes (GB), each bit covers two megabytes (MB) of address space. Increasing the granularity of the bitmap requires increasing the size, which consumes more storage resources and increases the cost of the bitmaps. Another problem is that the software must modify the bitmap every time the object is modified while a replica is unavailable, which increases input/output (IO) amplification. A third problem is that the software must create and persist one bitmap per fault replica of the object, further increasing costs. Finally, objects in object storage can have a logical size that differs from their physical size in the storage. A 256 GB object may be provisioned logically but occupy less than 256 GB of physical storage space. Nevertheless, the bitmap must cover the entire logical address space of the object.

### SUMMARY

In an embodiment, a method of resynchronizing a first replica of an object and a second replica of an object in an object storage system is described. The object storge system provides storage for a host executing storage software. The method includes determining, by the storage software in response to the second replica transitioning from failed to available, a stale sequence number for the second replica. The storage software associated the stale sequence number with the second replica when the second replica failed. The method includes querying, by the storage software, block-level metadata for the object using the stale sequence number. The block-level metadata relates logical blocks of the object with sequence numbers for operations on the object. The method includes determining, by the software as a result of the querying, a set of the logical blocks each related to a sequence number being the same or after the stale sequence number. The method includes copying, by the storage software, data of the set of logical blocks from the first replica to the second replica.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1A is a block diagram depicting a host computer system according to embodiments.

FIG. 1B is a block diagram depicting another host computer system according to embodiments.

FIG. 2 is a block diagram depicting logical operation of system software for managing an object storage system according to embodiments.

FIG. 3 is a block diagram depicting an example object.

FIG. 4 is a table 400 depicting an example relation between sequence numbers and block numbers.

FIG. 5 is a block diagram depicting block-level metadata according to embodiments.

FIG. 6 is a block diagram depicting pre-replica metadata according to embodiments.

FIG. 7 is a flow diagram depicting a method of handling a faulty replica according to an embodiment.

FIG. 8 is a flow diagram depicting a method of resynchronizing replicas in an object storage system according to embodiments.

### DETAILED DESCRIPTION

Resynchronization of objects in a virtual storage system is described. The virtual storage system comprises a virtual SAN or the like that implements an object storage system. A host executes storage software to access the object storage system. In embodiments, the host is part of a host cluster and local storage devices of the hosts are aggregated to implement the virtual storage system (e.g., a virtual SAN). An object can include multiple replicas stored in the storage system. In response to a failed replica, the storage software relates a stale sequence number with the failed replica. The storage software maintains unique sequence numbers for the operations targeting the storage system (e.g., write operations). Each operation includes a different sequence number. In an example, the storage software maintains monotonically increasing sequence numbers. When a failed replica is again available, the storage software queries block-level metadata with the stale sequence number. The block-level metadata relates logical blocks of the object with sequence numbers for operations on the object. As a result of the query, the storage software determines a set of logical blocks each related to a sequence number that is the same or after the stale sequence number in the sequence. The storage software then copies data in the set of logical blocks from an active replica or active replicas to the available replica to perform resynchronization. The storage software can then transition the available replica to become active.

The resynchronization techniques described herein overcome the problems associated with the bitmap described above. The IO amplification to track the modifications is amortized as they occur along with other metadata updates. The granularity of tracking is the same as the block size of the object and hence does not lead to any unnecessary resynchronization. Also, the technique can scale to track a large number of stale sequence numbers. These and further aspects of the techniques are described below with respect to the drawings.

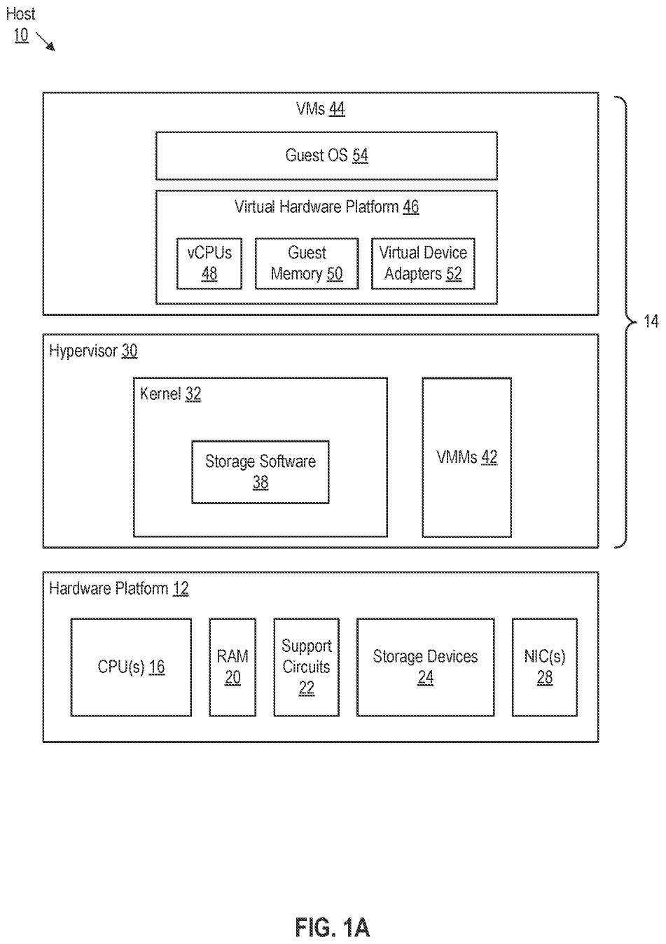

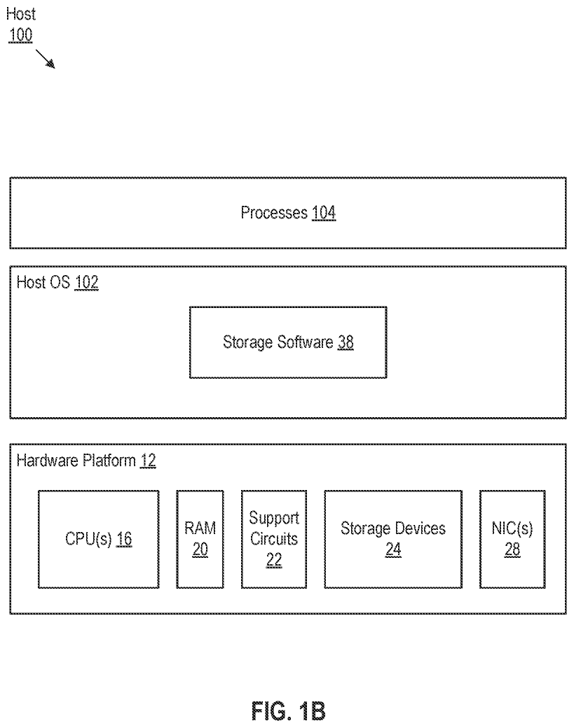

FIG. 1A is a block diagram depicting a host computer system (“host”) 10 according to embodiments. Host 10 is an example of a virtualized host. Host 10 includes software 14 executing on a hardware platform 12. Hardware platform 12 includes conventional components of a computing device, such as one or more central processing units (CPUs) 16, system memory (e.g., random access memory 20), one or more network interface controllers (NICs) 28, support circuits 22, and storage devices 24.

Each CPU 16 is configured to execute instructions, for example, executable instructions that perform one or more operations described herein, which may be stored in RAM 20. CPU(s) 16 include processors and each processor can be a core or hardware thread in a CPU 16. For example, a CPU 16 can be a microprocessor, with multiple cores and optionally multiple hardware threads for core(s), each having an x86 or ARM® architecture. The system memory is connected to a memory controller in each CPU 16 or in support circuits 22 and comprises volatile memory (e.g., RAM 20). Storage (e.g., each storage device 24) is connected to a peripheral interface in each CPU 16 or in support circuits 22. Storage is persistent (nonvolatile). As used herein, the term memory (as in system memory or RAM 20) is distinct from the term storage (as in a storage device 24).

Each NIC 28 enables host 10 to communicate with other devices through a network (not shown). Support circuits 22 include any of the various circuits that support CPUs, memory, and peripherals, such as circuitry on a mainboard to which CPUs, memory, and peripherals attach, including buses, bridges, cache, power supplies, clock circuits, data registers, and the like. Storage devices 24 include magnetic disks, SSDs, and the like as well as combinations thereof.

Software 14 comprises hypervisor 30, which provides a virtualization layer directly executing on hardware platform 12. In an embodiment, there is no intervening software, such as a host operating system (OS), between hypervisor 30 and hardware platform 12. Thus, hypervisor 30 is a Type-1 hypervisor (also known as a “bare-metal” hypervisor). Hypervisor 30 abstracts processor, memory, storage, and network resources of hardware platform 12 to provide a virtual machine execution space within which multiple virtual machines (VM) 44 may be concurrently instantiated and executed.

Hypervisor 30 includes a kernel 32 and virtual machine monitors (VMMs) 42. Kernel 32 is software that controls access to physical resources of hardware platform 12 among VMs 44 and processes of hypervisor 30. Kernel 32 includes storage software 38. Storage software 38 includes one or more layers of software for handling storage input/output (IO) requests from hypervisor 30 and/or guest software in VMs 44 to storage devices 24. A VMM 42 implements virtualization of the instruction set architecture (ISA) of CPU(s) 16, as well as other hardware devices made available to VMs 44. A VMM 42 is a process controlled by kernel 32.

A VM 44 includes guest software comprising a guest OS 54. Guest OS 54 executes on a virtual hardware platform 46 provided by one or more VMMs 42. Guest OS 54 can be any commodity operating system known in the art. Virtual hardware platform 46 includes virtual CPUs (vCPUs) 48, guest memory 50, and virtual device adapters 52. Each vCPU 48 can be a VMM thread. A VMM 42 maintains page tables that map guest memory 50 (sometimes referred to as guest physical memory) to host memory (sometimes referred to as host physical memory). Virtual device adapters 52 can include a virtual storage adapter for accessing storage.

FIG. 1B is a block diagram depicting a host 100 according to embodiments. Host 100 is an example of a non-virtualized host. Host 100 comprises a host OS 102 executing on a hardware platform. The hardware platform in FIG. 1B is identical to hardware platform 12 and thus designated with identical reference numerals. Host OS 102 can be any commodity operating system known in the art. Host OS 102 includes functionality of kernel 32 as shown in FIG. 1A, including storage software 38. Host OS 102 manages processes 104, rather than virtual machines. The object replica resynchronization techniques described herein can be performed in a virtualized host, such as that shown in FIG. 1A, or a non-virtualized host, such as that shown in FIG. 1B.

In embodiments, storage software 38 accesses local storage devices (e.g., storage devices 24 in hardware platform 12). In other embodiments, storage software 38 accesses storage that is remote from hardware platform 12 (e.g., shared storage accessible over a network through NICs 28, host bus adaptors, or the like). Shared storage can include one or more storage arrays, such as a storage area network (SAN), network attached storage (NAS), or the like. Shared storage may comprise magnetic disks, solid-state disks, flash memory, and the like as well as combinations thereof. In some embodiments, local storage of a host (e.g., storage devices 24) can be aggregated with local storage of other host(s) and provisioned as part of a virtual SAN, which is another form of shared storage. In embodiments, the shared storage comprises an object-based storage system (also referred to as object storage system). An object storage system stores data as objects and corresponding object metadata.

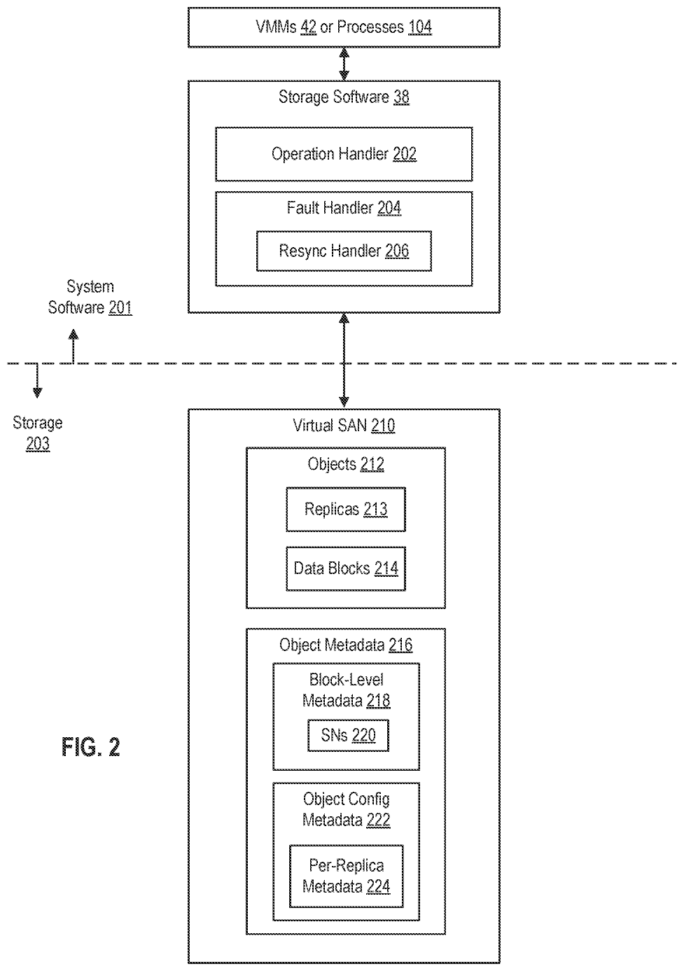

FIG. 2 is a block diagram depicting logical operation of system software for managing an object storage system according to embodiments. System software 202 can be hypervisor 30 in a virtualized host or host OS 102 in a non-virtualized host. VMMs 42 or processes 104 submit IO requests to storage software 38 depending on whether system software 202 is hypervisor 30 or host OS 102. Storage software 38 access virtual SAN 210. Virtual SAN 210 implements an object storage system using local storage devices of the host and other hosts in a cluster. While a virtual SAN is described as an example object storage system, those skilled in the art will appreciate that other types of object storage systems can be used with the techniques described herein.

Virtual SAN 210 stores objects 212 and object metadata 216. An object 212 is a container for data. An object 212 can have a logical size independent of the physical size of the object on the storage devices (e.g., using thin provisioning). For example, an object 212 can be provisioned having a logical size of 256 GB, but store data comprising less than 256 GB of physical storage. Each object 212 comprises data blocks 214. A data block 214 is the smallest operational unit of an object 212. Operations on virtual SAN 210 read and write in terms of one or more data blocks 214. Data blocks 214 are part of a logical address space of an object 212. Data blocks 214 are mapped to physical blocks of underlying storage devices. Objects 212 can include replicas 213. For example, an object 212 can include multiple replicas 213 to provide redundancy. Storage software 38 can store different replicas 213 of an object 212 on different physical storage devices for fault tolerance.

Storage software 38 maintains object metadata 216 for each object 212. For a given object 212, object metadata 216 includes block-level metadata 218 and object config metadata 222. Block-level metadata 218 describes the data blocks of the object and is valid for all replicas. Block-level metadata 218 can include, for example logical-to-physical address mappings, checksums, and the like. Block-level metadata 218 also includes sequence numbers (SNs) 220. Storage software 38 maintains unique sequence numbers for the operations performed on virtual SAN 210 (e.g., write operations). For example, the sequence numbers can be a monotonically increasing sequence. As each operation is performed, the sequence number is incremented (e.g., 1, 2, 3 . . . and so on). When a data block is modified by an operation, storage software 38 relates the current sequence number for the operation with the data block in block-level metadata 218. Object config metadata 222 includes metadata describing various properties of an object. Object config metadata 222 includes per-replica metadata 224. Per-replica metadata 224 includes metadata particular to a give replica 213 of an object 212.

Storage software 38 includes an operation handler 202 and a fault hander 204. Operation handler 202 performs the various operations on behalf of VMMs 42 or processes 104 (e.g., write operations). Operation handler 202 maintains block-level metadata 218, including the relation of sequence numbers 220 with data blocks 214. Fault hander 204 is configured to handle faults for replicas 213 of objects 212. Fault handler 204 includes resync handler 206 that implements replica resynchronization as described further below.

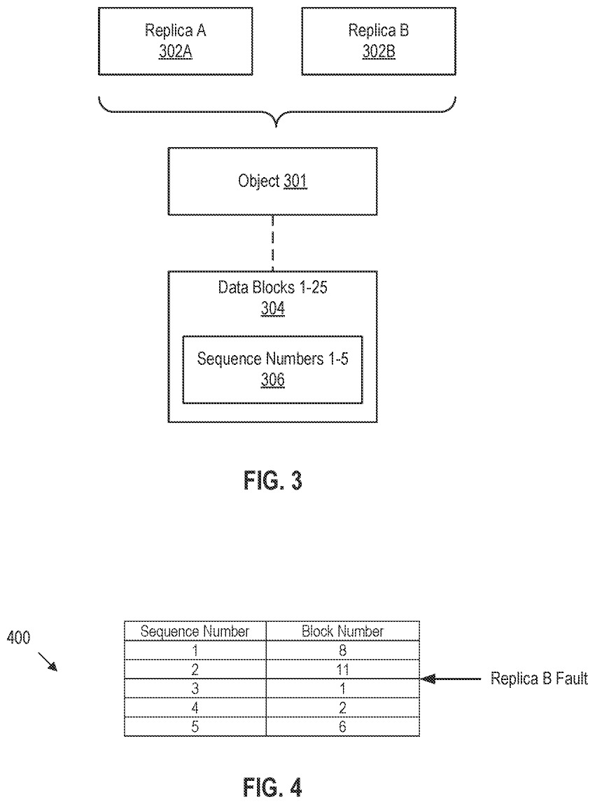

FIG. 3 is a block diagram depicting an example object. In the example, an object 301 includes two replicas 302A and 302B. Each replica 302A and 302B is stored as a separate object in the object storage system. When active, each replica 302A and 302B stores the same data. When a write operation targets object 301, storage software 38 modifies each replica 302A and 302B accordingly. Object 301 includes data blocks 304. In the example, assume object 301 comprises 25 data blocks logically identified as data blocks 1-25. Data blocks 304 are mapped to different physical blocks of underlying storage devices for each of replicas 302A and 302B. Data blocks 304 are related to sequence numbers 306 (e.g., sequence numbers 1-5 in the example corresponding to five operations).

FIG. 4 is a table 400 depicting an example relation between sequence numbers and block numbers. Table 400 depicts sequence numbers 1-5 corresponding to five operations (e.g., five write operations). Data block “8” is modified in an operation with sequence number 1; a data block “11” is modified in an operation with sequence number 2; a data block “1” is modified in an operation with sequence number 3; a data block “2” is modified in an operation with sequence number 4; and a data block “6” is modified in an operation with sequence number 5. In the example, assume replica B (replica 302B) fails after sequence number 2. Thus, the modification to data blocks 1, 2, and 6 for sequence numbers 3, 4, and 5 are not propagated to replica B, but rather only to replica A (replica 302A).

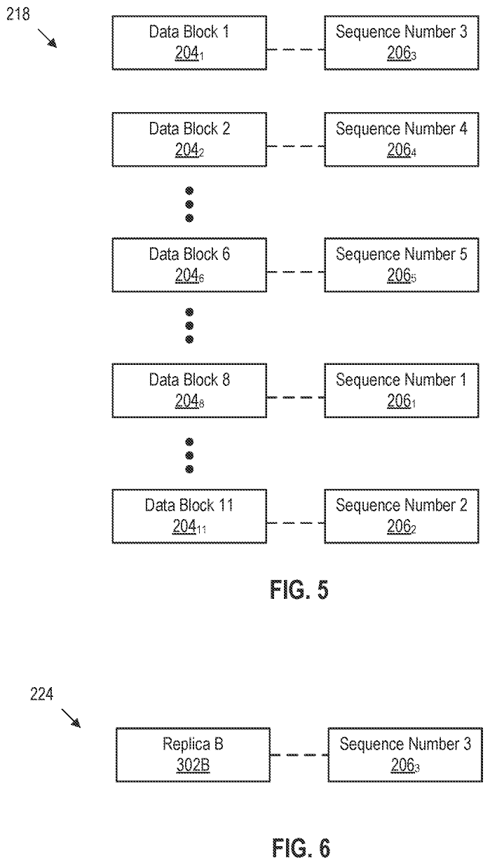

FIG. 5 is a block diagram depicting block-level metadata 218 according to embodiments. FIG. 5 shows block-level metadata 218 based on the example above in FIG. 4. In block-level metadata 218, data block 1 (2041) is related to sequence number 3 (2063). Data block 2 (2042) is related to sequence number 4 (2064). Data block 6 (2046) is related to sequence number 5 (2065). Data block 8 (2048) is related to sequence number 1 (2061). Data block 11 (20411) is related to sequence number 2 (2062). Operation handler 202 updates block-level metadata 218 as the operations are performed.

FIG. 6 is a block diagram depicting pre-replica metadata 224 according to embodiments. FIG. 6 shows per-replica metadata 224 for replica B (302B) after its failure. As shown, replica B (302B) is related to sequence number 3 (2063). Sequence number 3 becomes a stale sequence number for replica B (302B). This indicates that the operations with sequence numbers 3 and later were unable to modify data on replica B (302B) due to its failure.

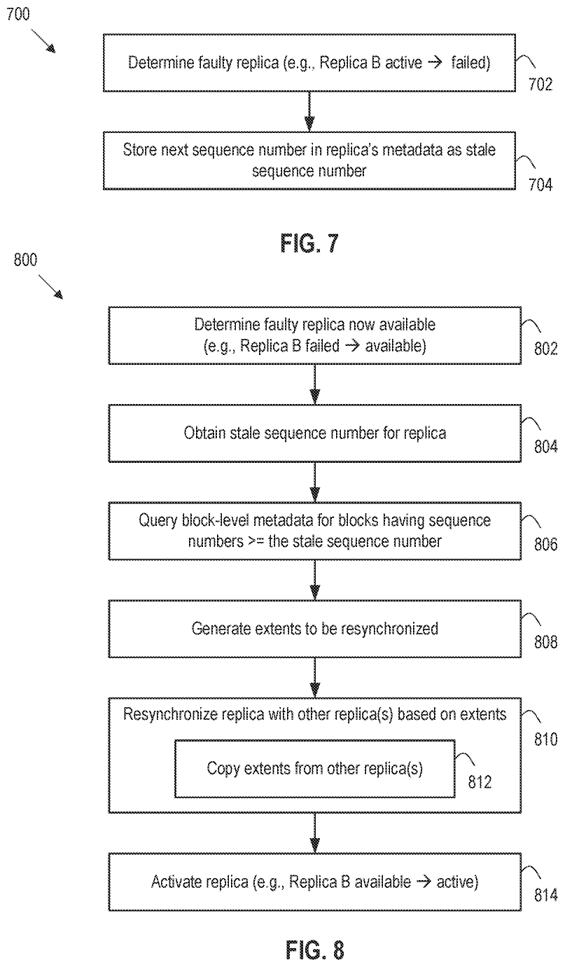

FIG. 7 is a flow diagram depicting a method 700 of handling a faulty replica according to an embodiment. Method 700 begins at step 702, where fault handler 204 determines that a replica is faulty (e.g., replica B transitions from being active to being failed). A replica fails if it becomes inaccessible due to the underlying physical storage being inaccessible. At step 704, fault hander 204 stores the next sequence number in the replica's metadata as a stale sequence number. In the example above, fault handler 204 stores sequence number 3 in relation to replica B.

FIG. 8 is a flow diagram depicting a method 800 of resynchronizing replicas in an object storage system according to embodiments. Method 800 begins at step 802, where resync handler 206 determines that a faulty replica is now available. In the example above, replica B failed. Assume in method 800 replica B is now available after sequence number 5. In such case, replica B was failed during operations for sequence numbers 3-5. At step 804, resync handler 306 obtains the stale sequence number for the replica (e.g., sequence number 3 for replica B). At step 806, resync handler 306 queries block-level metadata 218 for blocks having sequence numbers greater than or equal to the stale sequence number. That is, for blocks having sequence numbers that occurred while the replica was failed. In the example, sequence numbers 3, 4, and 5 are greater than or equal to the stale sequence number (e.g., sequence number 3). The blocks returned in the query are data blocks 1, 2, and 6.

At step 808, resync handler 306 generates extents to be resynchronized. An extent comprises a starting data block and an offset from the starting data block (in terms of a number of data blocks). An extent can encompass one or more data blocks using two items of data (the starting data block number and an offset number). In the example above, one extent is <1, 2> and another extent is <6, 1>. The extent <1, 2> indicates starting data block 1 and an offset of 2, which encompasses both data blocks 1 and 2. Each of data blocks 1 and 2 were modified in operations with sequence numbers 3 and 4, respectively, equal to or greater than the stale sequence number. The extent <6, 1> indicates a starting data block 1 and an offset of 1, which encompasses only data block 6.

At step 810, resync handler 306 resynchronizes with other replica(s) based on the extents. For example, at step 812, resync handler 306 copies data at the extents from other replica(s) to the available replica. In the example, resync handler 306 copies data blocks 1, 2, and 6 from replica A to replica B. If any of data blocks 1, 2, and 6 are present in replica B, such data blocks are overwritten with the data blocks obtained from replica A. At step 814, resync handler 306 activates the replica (e.g., replica B).

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of resynchronizing a first replica of an object and a second replica of an object in an object storage system, the object storge system providing storage for a host executing storage software, the method comprising:
determining, by the storage software in response to the second replica transitioning from failed to available, a stale sequence number for the second replica, the storage software having associated the stale sequence number with the second replica when the second replica failed;
querying, by the storage software, block-level metadata for the object using the stale sequence number, the block-level metadata relating logical blocks of the object with sequence numbers for operations on the object;
determining, by the software as a result of the querying, a set of the logical blocks each related to a sequence number being the same or after the stale sequence number; and
copying, by the storage software, data of the set of logical blocks from the first replica to the second replica.

2. The method of claim 1, further comprising:
activating, by the storage software, the second replica after the copying.

3. The method of claim 1, wherein the storage software determines extents representing the set of logical blocks from the querying, each of the extents indicating a starting logical block and an offset from the starting logical block, and wherein the storage software copies the data using the extents.

4. The method of claim 1, wherein the sequence numbers are unique and the storage software changes the sequence number for each of the operations.

5. The method of claim 4, wherein the stale sequence number is one of the sequence numbers.

6. The method of claim 1, wherein the host is part of a cluster of hosts, the hosts including local storage devices aggregated to form the object storage system.

7. The method of claim 6, wherein the block-level metadata further relates the logical blocks with physical blocks of the local storage devices.

8. A non-transitory computer readable medium comprising instructions to be executed in a computing device to cause the computing device to carry out a method of resynchronizing a first replica of an object and a second replica of an object in an object storage system, the object storge system providing storage for a host executing storage software, the method comprising:
determining, by the storage software in response to the second replica transitioning from failed to available, a stale sequence number for the second replica, the storage software having associated the stale sequence number with the second replica when the second replica failed;
querying, by the storage software, block-level metadata for the object using the stale sequence number, the block-level metadata relating logical blocks of the object with sequence numbers for operations on the object;
determining, by the software as a result of the querying, a set of the logical blocks each related to a sequence number being the same or after the stale sequence number; and
copying, by the storage software, data of the set of logical blocks from the first replica to the second replica.

9. The non-transitory computer readable medium of claim 8, further comprising:
activating, by the storage software, the second replica after the copying.

10. The non-transitory computer readable medium of claim 8, wherein the storage software determines extents representing the set of logical blocks from the querying, each of the extents indicating a starting logical block and an offset from the starting logical block, and wherein the storage software copies the data using the extents.

11. The non-transitory computer readable medium of claim 8, wherein the sequence numbers are unique and the storage software changes the sequence number for each of the operations.

12. The non-transitory computer readable medium of claim 11, wherein the stale sequence number is one of the sequence numbers.

13. The non-transitory computer readable medium of claim 8, wherein the host is part of a cluster of hosts, the hosts including local storage devices aggregated to form the object storage system.

14. The non-transitory computer readable medium of claim 13, wherein the block-level metadata further relates the logical blocks with physical blocks of the local storage devices.

15. A computer system, comprising:
a hardware platform comprising an interface to an object storage system, the object storage system storing an object having a first replica and a second replica;
system software, executing on the hardware platform, including storage software configured to:
determine, in response to the second replica transitioning from failed to available, a stale sequence number for the second replica, the storage software having associated the stale sequence number with the second replica when the second replica failed;
query block-level metadata for the object using the stale sequence number, the block-level metadata relating logical blocks of the object with sequence numbers for operations on the object;
determine, as a result of the querying, a set of the logical blocks each related to a sequence number being the same or after the stale sequence number; and
copy data of the set of logical blocks from the first replica to the second replica.

16. The computer system of claim 15, wherein the storage software is configured to:
activate the second replica after the copying.

17. The computer system of claim 15, wherein the storage software determines extents representing the set of logical blocks from the querying, each of the extents indicating a starting logical block and an offset from the starting logical block, and wherein the storage software copies the data using the extents.

18. The computer system of claim 15, wherein the sequence numbers are unique and the storage software changes the sequence number for each of the operations.

19. The computer system of claim 18, wherein the stale sequence number is one of the sequence numbers.

20. The computer system of claim 15, wherein the host is part of a cluster of hosts, the hosts including local storage devices aggregated to form the object storage system.
